(19) United States
(12) Patent Application Publication
(10) Pub. No.: US 2012/0229821 A1
(43) Pub. Date: Sep. 13, 2012

(54) INTEGRATED CONTACT IMAGE SENSOR MODULE AND IMAGE SCANNING SYSTEM

(76) Inventor: Shih-Huang CHEN, Hsin-Chu (TW)

(21) Appl. No.: 13/117,466

(22) Filed: May 27, 2011

(30) Foreign Application Priority Data
Mar. 10, 2011 (TW) 100108049

(51) Int. Cl. H04N 1/46; G06K 15/02; G06F 3/12; H04N 1/04

(52) U.S. Cl. 358/1.5; 358/475; 358/509; 358/1.15

(57) ABSTRACT

An integrated contact image sensor module (CISM) is provided. A light switch circuit turns on a light source according to a light control signal. A contact image sensor captures an image when the light source is turned on and generates an analog signal corresponding to the image. An analog to digital converter coupled to the contact image sensor converts the analog signal into scan data. A controller coupled to the light switch circuit provides the light control signal to the light switch circuit according to a motion signal and provides a clock signal to the analog to digital converter, so as to convert the analog signal into the scan data. The controller further provides an interface signal corresponding to the scan data, to an interface module according to the motion signal, and the interface signal conforms to a specific transmission protocol.

### CROSS REFERENCE TO RELATED APPLICATIONS

This Application claims priority of Taiwan Patent Application No. 100108049, filed on Mar. 10, 2011, the entirety of which is incorporated by reference herein.

### BACKGROUND OF THE INVENTION

1. Field of the Invention

The present invention is related to an integrated contact image sensor module (CISM), and more particularly to an integrated CISM that captures an image according to a motion signal and then transmits data with a universal transmission interface.

2. Description of the Related Art

Image scanners are commonly used in offices or homes for scanning. For example, a user can use an image scanner to scan documents, photographs or films, so as to print or store the scanned image.

When an image scanner is operated, an image sensing module such as a charge couple device (CCD) or contact image sensor (CIS), is employed to generate electronic signals of images. Since the contact image sensor has less volume than the charge couple device, the contact image sensors are usually applied to scanners, multi-function business machines or photocopiers.

A contact image sensor normally shines light on an object to be scanned and focuses the reflected light by a lens group on a CCD or a complimentary metal-oxide semiconductor (CMOS) light sensor, and then converts the received optical signals to electronic signals for generating pixel data. Therefore, by moving the contact image sensor to perform scanning, the objects (e.g. documents, photographs or films) are recorded on, output to or transmitted to other electronic devices. However, in a typical contact image sensor module (CISM), it has no relationship between motion information of the contact image sensor and operations of the sensor module. Therefore, in order to complete basic scanning, a user needs to know all of the operations of the CISM, to understand the mutual relationships between the modules within the CISM.

### BRIEF SUMMARY OF THE INVENTION

An integrated contact image sensor module (CISM) and an image scanning system are provided. An embodiment of a CISM comprises a light switch circuit, a contact image sensor, an analog to digital converter coupled to the contact image sensor and a controller coupled to the light switch circuit. The light switch circuit turns on a light source according to a light control signal. The contact image sensor captures an image when the light source is turned on and generates an analog signal corresponding to the image. The analog to digital converter converts the analog signal into scan data. The controller provides the light control signal to the light switch circuit according to a motion signal and provides a clock signal to the analog to digital converter, so as to convert the analog signal into the scan data. The controller further provides an interface signal corresponding to the scan data, to an interface module according to the motion signal, and the interface signal conforms to a specific transmission protocol.

Furthermore, an embodiment of an image scanning system is provided. The image scanning system comprises an interface module and an integrated contact image sensor module (CISM). The CISM comprises a light switch circuit, a contact image sensor, an analog to digital converter coupled to the contact image sensor and a controller coupled to the light switch circuit. The light switch circuit turns on a light source according to a light control signal. The contact image sensor captures an image when the light source is turned on and generates an analog signal corresponding to the image. The analog to digital converter converts the analog signal into scan data. The controller provides the light control signal to the light switch circuit according to a motion signal and provides a clock signal to the analog to digital converter, so as to convert the analog signal into the scan data. The controller further provides an interface signal corresponding to the scan data, to the interface module according to the motion signal, and the interface signal conforms to a specific transmission protocol.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows an image scanning system according to an embodiment of the invention;

FIG. 2 shows a waveform illustrating the signals of the image scanning system of FIG. 1;

FIG. 3 shows an image scanning system according to another embodiment of the invention; and

FIG. 4 shows an image scanning system 400 according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

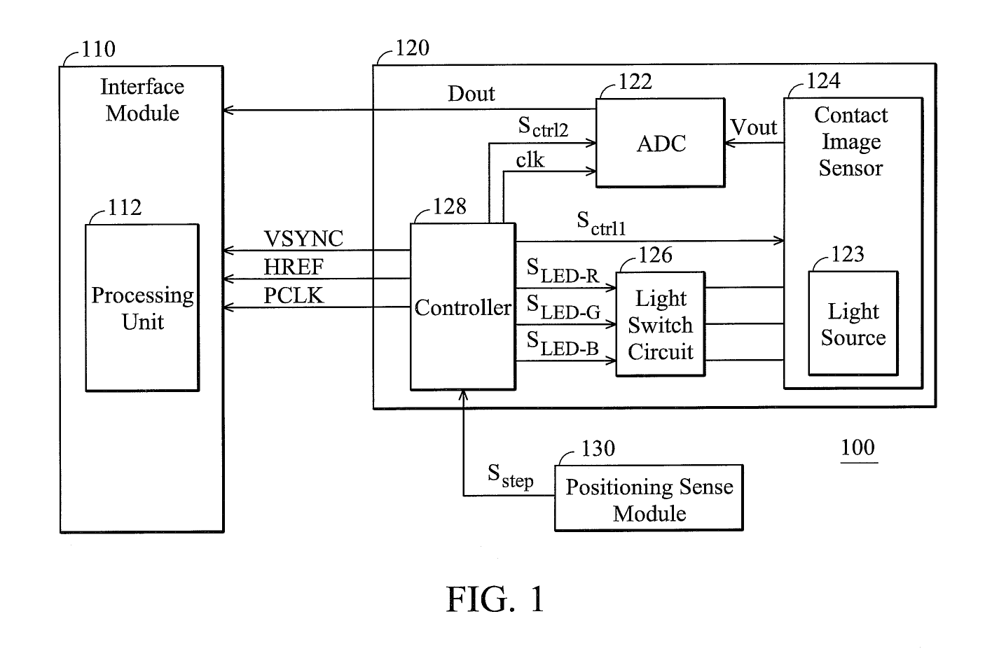

FIG. 1 shows an image scanning system 100 according to an embodiment of the invention. The image scanning system 100 comprises an interface module 110, an integrated contact image sensor module (CISM) 120 and a positioning sense module 130. The integrated CISM 120 comprises an analog to digital converter (ADC) 122, a contact image sensor (CIS) 124, a light switch circuit 126 and a controller 128. In the embodiment, the image scanning system 100 may be a push type scanner. Therefore, the integrated CISM 120 scans an object (e.g. pictures or texts) to obtain an image when the positioning sense module 130 detects that the image scanning system 100 has been moved. Then, the integrated CISM 120 transmits the scanned data to the interface module 110 for subsequent processing.

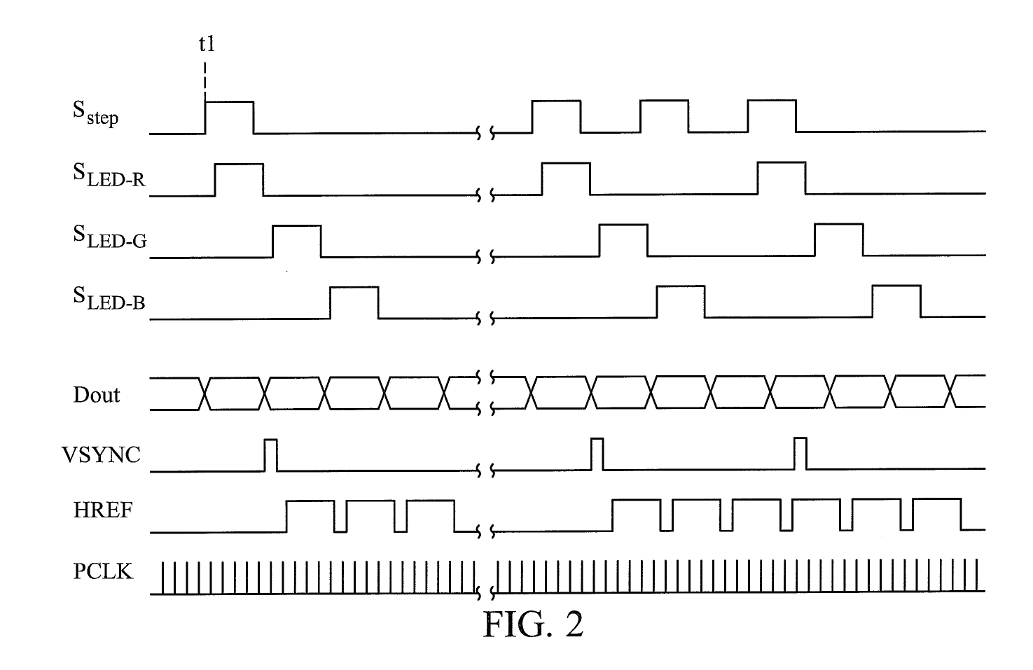

FIG. 2 shows a waveform illustrating the signals of the image scanning system 100 of FIG. 1, which is an example and does not limit the invention. Referring to FIG. 1 and FIG. 2 together, firstly, when it is detected that the image scanning system 100 has been moved, the positioning sense module 130 generates a motion signal Sₛₜₑₚ to notify the integrated CISM 120, as shown in time t1 of FIG. 2. Next, the controller 128 of the integrated CISM 120 generates a control signal S_{ctrl1} to the contact image sensor 124, so as to control the contact image sensor 124 to perform object scanning. Simultaneously, the controller 128 also appropriately generates the light control signals S_{LED-R}, S_{LED-G} and S_{LED-B} to the light switch circuit 126 in sequence, to turn on a light source 123 of the contact image sensor 124 and to change colors of the light source 123. In the embodiment, the light control signals S_{LED-R}, S_{LED-G} and S_{LED-B} respectively correspond to red, green and blue colors, thus the image scanning system 100 can perform a color scan for an object. In one embodiment, the controller 128 may also generate the light control signals corresponding to black and white colors, so that the image scanning system 100 can perform a monochrome scan for an object. In addition, according to various applications, the controller 128 also generates the light control signals corresponding to applications, to control the light source 123, thereby the light source 123 may provide infrared rays, ultraviolet (UV) rays or lights with various illuminations to perform object scanning. Next, following the changes in the light colors, the contact image sensor 124 performs the object scanning to obtain a corresponding analog signal Vout. It is to be noted that the controller 128 controls the contact image sensor 124 to stop scanning when the motion signal Sₛₜₑₚ indicates that the image scanning system 100 is motionless. Simultaneously, the controller 128 also turns off the light source 123. Furthermore, when the motion signal Sₛₜₑₚ indicates that the image scanning system 100 has been moved, the controller 128 may also adjust the turn-on time of the light source 123 according to various applications.

Moreover, the controller 128 further provides a clock signal clk and a control signal S_{ctrl2} to the ADC 122 when the motion signal Sₛₜₑₚ indicates that the image scanning system 100 has been moved. Thus, the ADC 122 converts the analog signal Vout into a digital scan data Dout, and than transmits the scan data Dout to the interface module 110. Simultaneously, the controller 128 also provides the interface signals PCLK, HREF and VSYNC to the interface module 110 when the motion signal Sₛₜₑₚ indicates that the image scanning system 100 has been moved, wherein the interface signals PCLK, HREF and VSYNC are synchronization (sync) signals that conform to a transmission protocol of a subminiature photograph module, for example, the signal PCLK is a pixel sync clock signal, the signal HREF is a horizontal sync signal and the VSYNC is a vertical sync signal. Therefore, a processing unit 112 of the interface module 110 can read the scan data Dout according to the interface signals PCLK, HREF and VSYNC, to obtain the scanned image. For example, the processing unit 112 may be a digital still camera (DSC) chip, thus the interface module 110 and the integrated CISM 120 have the same interface standards, such that the DSC chip directly reads the signals provided by the integrated CISM 120 without additional processes. Furthermore, the processing unit 112 may be a transmission integrated chip (IC) that conforms to universal serial bus (USB) specifications, so that the transmission IC can easily transmit the image data to a backend system (e.g. PC) for storage or use.

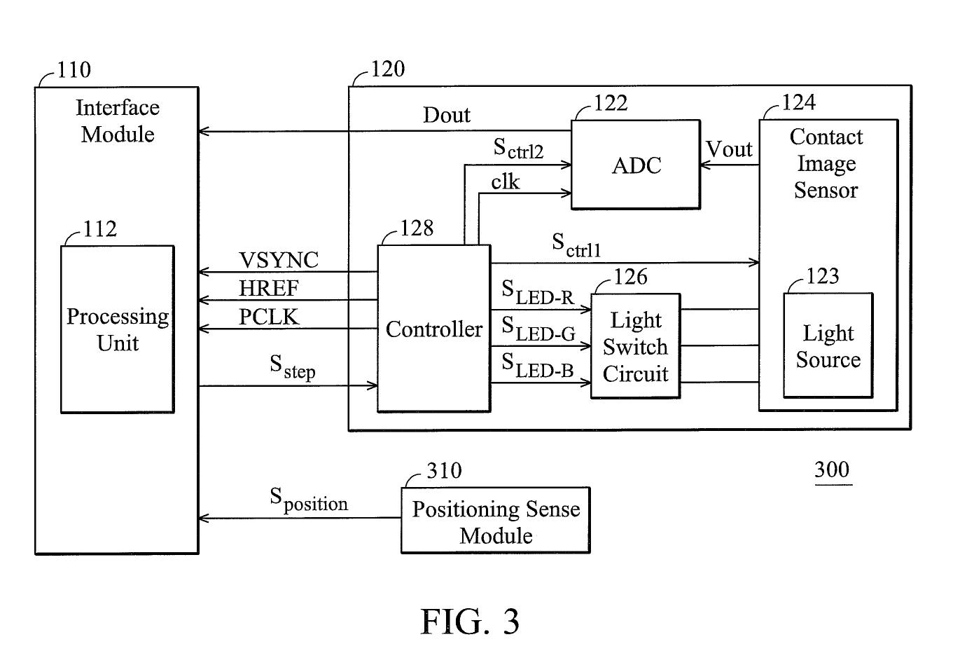

FIG. 3 shows an image scanning system 300 according to another embodiment of the invention. In FIG. 3, a positioning sense module 310 generates a position signal Sₚₒₛᵢₜᵢₒₙ to the interface module 110 in response to a motion of the image scanning system 300. Next, the interface module 110 generates a motion signal Sₛₜₑₚ to notify the integrated CISM 120 according to the position signal Sₚₒₛᵢₜᵢₒₙ, thus the controller 128 within the integrated CISM 120 enables the contact image sensor 124 and turns on/enables the light source 123 to perform object scanning. Furthermore, the interface module 110 also obtains a motion direction of the image scanning system 300 according to the position signal Sₚₒₛᵢₜᵢₒₙ. Therefore, according to the obtained motion direction and the signals from the integrated CISM 120, the interface module 110 further processes the scanned image. For example, in response to the motion direction, the interface module 110 displays the scanned image for user view.

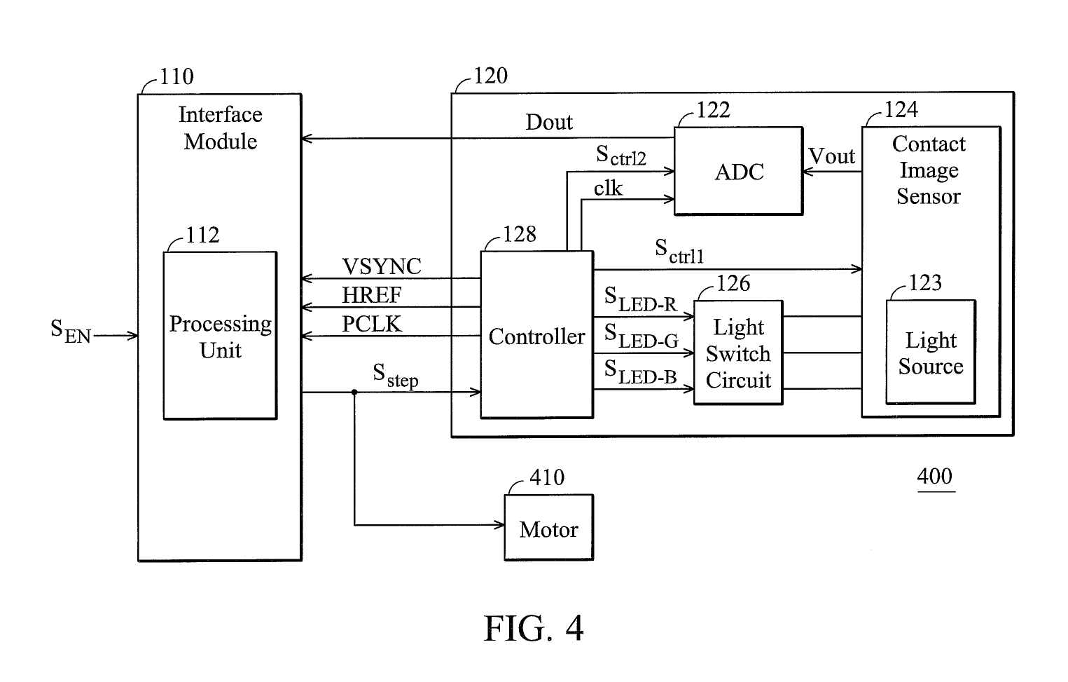

FIG. 4 shows an image scanning system 400 according to another embodiment of the invention. In the embodiment, the image scanning system 400 may be a sheetfed scanner or a flatbed scanner. When an enable signal S_{EN} indicates that object scanning has begun, the interface module 110 generates a motion signal Sₛₜₑₚ to the integrated CISM 120 and a motor 410, so as to control the operation of the motor 410 for object scanning.

As described above, the integrated CISM of the invention appropriately and sequentially turns on a light source and changes the light colors according to the motion information of the image scanning system, to perform object scanning. In addition, the integrated CISM also provides the signals that conform to a transmission protocol of a subminiature photograph module, thereby the integrated CISM can use the interface module to transmit image data to a backend image processing module. Therefore, after receiving the image data, only basic processes and arrangements need to be performed by the backend image processing module to completely obtain a scanned image, thus significantly reducing complexity for users.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An integrated contact image sensor module (CISM), comprising:
a light switch circuit, turning on a light source according to a light control signal;
a contact image sensor, capturing an image when the light source is turned on and generating an analog signal corresponding to the image;
an analog to digital converter coupled to the contact image sensor, converting the analog signal into scan data; and
a controller coupled to the light switch circuit, providing the light control signal to the light switch circuit according to a motion signal and providing a clock signal to the analog to digital converter, so as to convert the analog signal into the scan data,
wherein the controller further provides an interface signal corresponding to the scan data, to an interface module according to the motion signal, and the interface signal conforms to a specific transmission protocol.

2. The integrated CISM as claimed in claim 1, wherein the motion signal is provided by a positioning sense module.

3. The integrated CISM as claimed in claim 1, wherein the light switch circuit further controls the colors and turn-on time of the light source according to the light control signal.

4. The integrated CISM as claimed in claim 1, wherein the interface signal conforms to a transmission protocol of a subminiature photograph module.

5. The integrated CISM as claimed in claim 1, wherein the controller and the analog to digital converter respectively provide the interface signal and the scan data to the interface module for obtaining the image according to the interface signal and the scan data.

6. The integrated CISM as claimed in claim 1, wherein the interface module transmits the scan data to a backend system according to the interface signal, so that the backend system obtains the image according to the scan data or stores the scan data.

7. The integrated CISM as claimed in claim 1, wherein the motion signal is provided by the interface module.

8. An image scanning system, comprising:
an interface module; and
an integrated contact image sensor module (CISM), comprising:
a light switch circuit, turning on a light source according to a light control signal;
a contact image sensor, capturing an image when the light source is turned on and generating an analog signal corresponding to the image;
an analog to digital converter coupled to the contact image sensor, converting the analog signal into scan data; and
a controller coupled to the light switch circuit, providing the light control signal to the light switch circuit according to a motion signal and providing a clock signal to the analog to digital converter, so as to convert the analog signal into the scan data,
wherein the controller further provides an interface signal corresponding to the scan data, to the interface module according to the motion signal, and the interface signal conforms to a specific transmission protocol.

9. The image scanning system as claimed in claim 8, further comprising:
a positioning sense module, providing the motion signal.

10. The image scanning system as claimed in claim 8, further comprising:
a positioning sense module, detecting motion of the integrated CISM to generate a position signal,
wherein the interface module generates the motion signal according to the position signal.

11. The image scanning system as claimed in claim 10, further comprising:
a motor,
wherein the interface module provides the motion signal to the motor, to control operations of the motor.

12. The image scanning system as claimed in claim 8, wherein the light switch circuit further controls the colors and turn-on time of the light source according to the light control signal.

13. The image scanning system as claimed in claim 8, wherein the interface signal conforms to a transmission protocol of a subminiature photograph module.

14. The image scanning system as claimed in claim 8, wherein the controller and the analog to digital converter respectively provide the interface signal and the scan data to the interface module for obtaining the image according to the interface signal and the scan data.

15. The image scanning system as claimed in claim 8, wherein the interface module transmits the scan data to a backend system according to the interface signal, so that the backend system can obtain the image according to the scan data or store the scan data.
